(19) United States
(12) Patent Application Publication
(10) Pub. No.: US 2007/0101598 A1
(43) Pub. Date: May 10, 2007

(54) Drawer know pull measuring jig

(76) Inventor: Anthony W. Miro, Naples, FL (US)

Correspondence Address: EDWARD M. LIVINGSTON, PA, 963 TRAIL TERRACE DRIVE, NAPLES, FL, 34103, US

(21) Appl. No.: 11/268,841

(22) Filed: Nov. 8, 2005

(51) Int. Cl. B25H 7/00

(52) U.S. Cl. 33/667

(57) ABSTRACT

A drawer knob pull measuring jig (1) comprising a suspension plate (2) and a drill plate (3) adjustably secured to one another via at least one pole (4). At least one pilot hole (5) is located in the drill plate (3). A second embodiment of the measuring jig (1) has at least one sliding block (14) is located on the drill plate (3) so as to permit a user to adjustably select the distances between pilot holes (5). The use of the present invention will permit a person to quickly identify the location of a hole to be drilled on a drawer face (9) for a knob pull in an accurate and precise manner.

### BACKGROUND OF THE INVENTION

This invention relates to measuring jigs, more particularly, a drawer knob pull measuring jig that permits a person to quickly identify the location of a hole to be drilled on a drawer for a knob pull in an accurate and precise manner.

Many drawer manufacturers do not include holes in the drawer face for a variety of reasons. For instance, customers prefer to personalize the drawer face by selecting his or her own knob pulls, which vary in hole locations. In addition, in order to further customize the drawer, customers select the location of the knob pulls, which are also known as jewelry, on the drawer face. Although drilling holes into a drawer for the knob pulls may seem like a simple task, it is more difficult than one realizes.

Accurate measuring is an essential step when drilling holes for knob pulls. Currently, many drawer installers or do-it-yourselfers use a standard tape measure to measure the horizontal and vertical distances from the edges of the drawer face to pinpoint the exact location of the hole to be drilled. Once the first drawer hole is drilled, the person then must measure each and every drawer face thereafter to achieve the same result. Not only is this method time-consuming, but if a measurement is slightly off, the resulting drawer is a painful eyesore as the knobs do not line-up appropriately and may require the drawer to be replaced. Although there currently exists a wide range of measuring jigs which attempt to quickly and accurately measure the location for a knob pull hole, the jigs are flawed for several reasons. First, although the drawer faces may appear to be identical in size, slight size differentiations, such as 22 inches vs. 22 1/16 inches in width, may cause the spacing from one end of the drawer face to the center of the drawer face to be different from one another. Thus, jigs that attach to both sides of the drawer face need to be readjusted each and every time a drawer face is measured due to the slight discrepancies in drawer size.

In addition, the current jigs are either too cumbersome for quick use, not versatile enough to use on a wide variety of drawer sizes, not durable enough for heavy use, clamp onto the drawer faces, which is time consuming or are simply too large in size for easy portability.

Thus, a need exists for a cabinet drawer pull measuring jig that permits a person to quickly identify the location of a hole to be drilled on a drawer face for a knob pull in an accurate and precise manner, yet is versatile, lightweight, compact and durable.

The relevant prior art includes the following references:

| Patent No. | | |
|---|---|---|
| (U.S. unless stated otherwise) | Inventor | Issue/Publication Date |
| 4,873,769 | Casanave | Oct. 17, 1989 |
| 4,791,732 | Bruno, Jr. et al. | Dec. 20, 1988 |
| 5,064,19 | Ericksen | Nov. 12, 1991 |
| 4,952,101 | Coombs | Aug. 28, 1990 |
| 4,684,299 | Laliberte | Aug. 04, 1987 |
| 2,821,027 | Billhimer, Sr. | Jan. 28, 1958 |
| 6,804,891 | Hurtgam | Oct. 19, 2004 |
| 5,807,036 | Lostlen | Sep. 15, 1998 |
| 3,583,823 | Eaton et al. | Jun. 08, 1971 |
| 2,582,606 | Riddle | Jan. 15, 1952 |
| 2,842,860 | Gray | Jul. 15, 1958 |
| 2,807,095 | Maxwell | Sep. 24, 1957 |
| 2,949,798 | Berta, Jr. | Aug. 23, 1960 |

### SUMMARY OF THE INVENTION

The primary object of the present invention is to provide a drawer knob pull measuring jig that allows a person to quickly identify the location of a hole to be drilled on a drawer face for a knob pull in an accurate and precise manner.

A further object of the present invention is to provide a drawer knob pull measuring jig that is adjustable.

An even further object of the present invention is to provide a drawer knob pull measuring jig that is lightweight.

Another object of the present invention is to provide a drawer knob pull measuring jig that is compact.

A further object of the present invention is to provide a drawer knob pull measuring jig that is durable.

An even further object of the present invention is to provide a drawer knob pull measuring jig that is easy to use.

The present invention fulfills the above and other objects by providing a drawer knob pull measuring jig comprising a suspension plate and a drill plate adjustably secured to one another via at least one pole. To use the drawer knob pull measuring jig, a person first positions the suspension plate on a drawer face top edge such that the jig is suspended from the drawer face. Then, he or she adjusts the height of the drill plate via thumb screws on the suspension plate so as to pinpoint the exact location in which a hole for a knob pull is to be drilled and secures the drill plate. Finally, a person inserts a drill bit into a pilot hole on the drill plate and drills a hole into the drawer face. Markings on the at least one pole connecting the drill plate and suspension plate permits the user to determine the measurements from the top of the drawer that were used. The user simply positions the measuring jig on another drawer to continue drilling accurate and precise holes into drawer faces. In addition, a person may adjust the height of the jig by loosening and tightening the thumb screws located in the drill plate so as to raise or lower the height of the drill plate. A variety of drill plates may be interchangeably used so as to provide a wide variety of pilot holes having various distances.

An alternate embodiment of the present invention fulfills the above and other objects by providing a drawer knob pull measuring jig comprising a suspension plate and a drill plate adjustably secured to one another via at least one pole. However, rather than a drill plate with a plurality of predeterminedly spaced pilot holes, the alternate embodiment of the present invention includes at least one sliding block located on the drill plate. The use of the at least one sliding block permits a user to adjustably select the distance between the pilot holes.

To use the second embodiment of the present invention, a person suspends the drawer knob pull measuring jig from a drawer face top edge as described above and adjusts the drill plate to the proper height. Then, he or she adjusts the sliding blocks so as to pinpoint the precise distance desired between the pilot holes.

The use of the present invention will permit a person to quickly identify the location of a hole to be drilled on a drawer for a knob pull in an accurate and precise manner.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a perspective plan view of a first embodiment of a drawer knob pull measuring jig of the present invention;

FIG. 2 is a perspective view of the first embodiment of the present invention in use;

FIG. 3 is a perspective plan view of a second embodiment of the present invention;

FIG. 4 is a side view of the second embodiment of the present invention in use; and

FIG. 5 is a perspective view of a drill plate of the second embodiment of the present invention.

### DESCRIPTION OF THE PREFERRED EMBODIMENTS

For purposes of describing the preferred embodiment, the terminology used in reference to the numbered components in the drawings is as follows:

| | |
|---|---|
| 1. | drawer knob pull measuring jig, generally |
| 2. | suspension plate |
| 3. | drill plate |
| 4. | pole |
| 5. | pilot hole |
| 6. | thumb screw |
| 7. | drill |
| 8. | drill bit |
| 9. | drawer face |
| 10. | drawer, generally |
| 11. | drawer face top edge |
| 12. | marking |
| 13. | slot |
| 14. | sliding block |
| 15. | aperture for pole |
| 16. | steel bushings |
| 17. | aperture for thumb screw |
| 18. | vertical side |
| 19. | horizontal side |

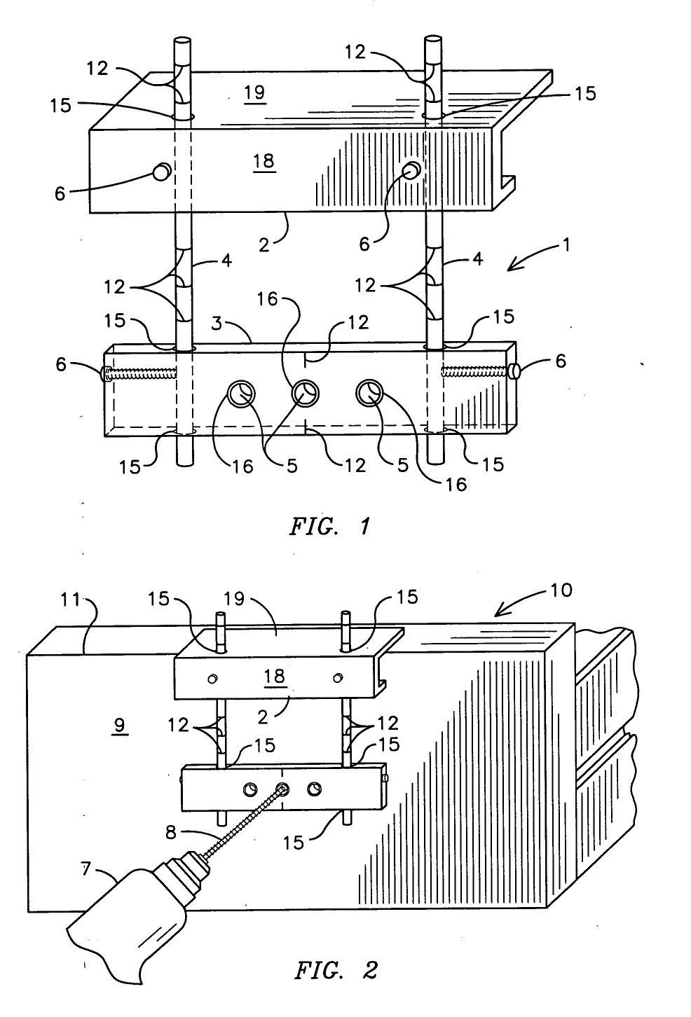

With reference to FIGS. 1 and 2, varying views of a first embodiment of a drawer knob pull measuring jig of the present invention is shown. The drawer knob pull measuring jig 1 includes a suspension plate 2 having a vertical side 18 and a horizontal side 19 wherein the suspension plate 2 is secured to a drill plate 3 via at least one pole 4. The poles 4 are inserted through apertures for poles 15 located on both the horizontal side 19 of the suspension plate 2 and the drill plate 3. The poles 4 are secured to the plates 2 and 3 via thumb screws 6. The suspension plate 2 is preferably J-shaped so as to permit a user to position the suspension plate 2 such that it is suspended from the drawer top face edge 11 and allows the drill plate 3 to be flush against a drawer 10. However, the suspension plate 2 may also be L-shaped or C-shaped, so long as the suspension plate 2 includes a vertical side 18 and a horizontal side 19 that is sufficiently wide to extend over a top of a drawer face 11. Markings 12 are located on the poles 4 so as indicate vertical distance between the suspension plate 2 and the drill plate 3. At least one pilot hole 5 is located on the drill plate 3 for the acceptance of a drill bit 8 of a drill 7. A marking 12 may be located near the at least one pilot hole 5 so as to allow a user to line up the pilot holes 5 with the center of the drawer.

To use the first embodiment of the present invention, a user first measures a distance from one side edge of a drawer 10 to a center of the drawer 10. Then, the user positions the suspension plate 2 in the center of the drawer 10 against a drawer face 9 and drawer face top edge 11. Then, the user adjusts the positioning of the drill plate 3 such that the pilot holes 5 are located at the desired location in front of the drawer face 9 by loosening the thumb screws 6 which secure the suspension plate 2 to the poles 4 and sliding the drill plate 3 up or down the poles 4. Finally, the user tightens the thumb screws 6 so as to secure the drill plate 3 in the desired position. For ease of use, markings 12 may be located on the poles 4 which indicate the vertical distance from the pilot holes 5 to the drawer face top edge 11.

Alternatively, the user may adjust the positioning of the drill plate 3 by loosening the thumb screws 6 which secure the drill plate 3 to the poles 4 and sliding the drill plate 3 up or down along the poles 4. In addition, the user may adjust both the drill plate 3 and the suspension plate 2 via loosening the thumb screws 6 on both the suspension plate 2 and the drill plate 3, sliding both plates 2 and 3 up or down on the poles 4 and tightening the thumb screws 6 so as to lock the plates 2 and 3 in place.

Finally, a user inserts a drill bit 8 into at least one pilot hole 5 and drills a hole for a knob pull. The pilot holes 5 preferably include steel bushings 16 so as to allow for a longer-lasting and more durable door knob pull measuring jig 1.

Once the desired holes are drilled into the drawer face 9, a user may then transfer the drawer knob pull measuring jig 1 to another drawer 10 to drill another hole. Unlike conventional drawer knob pull measuring jigs, however, the present invention need not be readjusted when drilling additional holes on other drawers 10. The user need only measure the distance from one side edge of a drawer 10 to the center in order to determine the center. Then, the user positions the jig 1 against the drawer face 9 and drawer face top edge 11 such that the jig 1 is centered on the drawer face 9. Because the suspension plate 2 and drill plate 3 are already positioned such that the pilot holes 5 are directly in front of the drawer face 9 where holes are desired to be drilled, the user simply drills additional holes into the drawer face 9. Thus, the user need not readjust the jig 1 from drawer 10 to drawer 10 in order to have identically-placed holes for knob pulls.

Interchangeable drill plates 3 may be used wherein the pilot holes 5 on each drill plate 3 have varying distances, such as 3 inches, 3¾ inches and 4 inches between a first and last pilot hole 5.

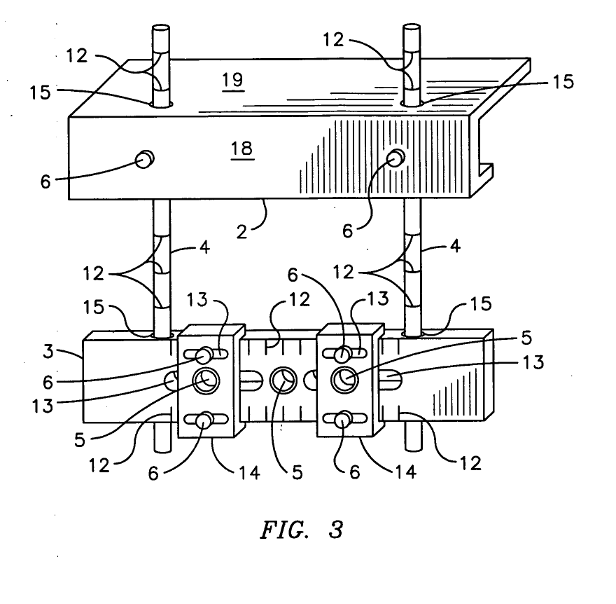

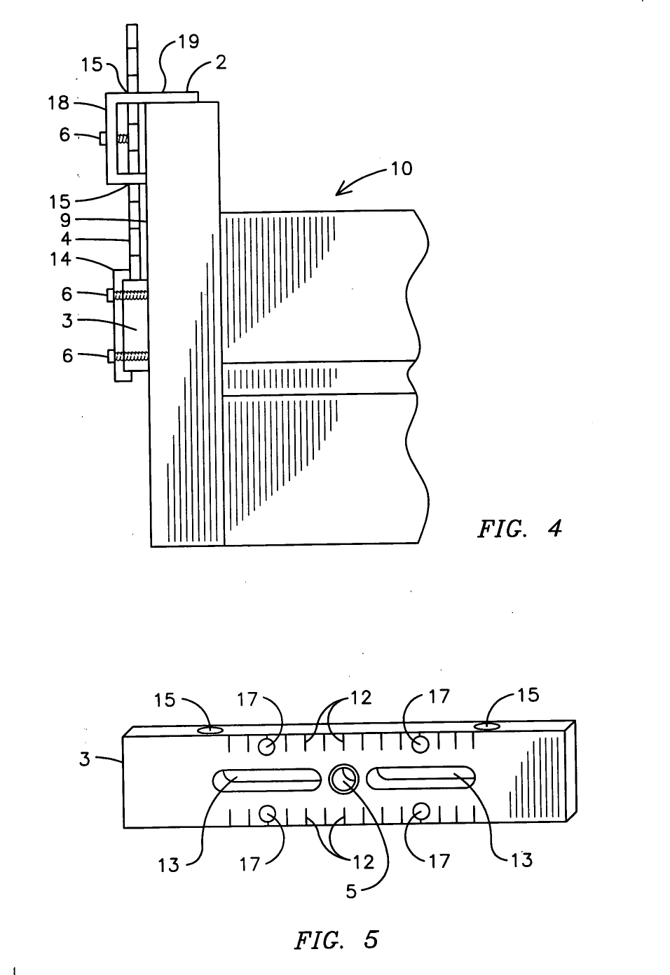

In FIGS. 3-5, varying views of a second embodiment of the present invention are shown. Similar to the first embodiment of the present invention, the second embodiment of the drawer knob pull measuring jig 1 includes a suspension plate 2, a drill plate 3 and poles 4. However, rather than having stationary pilot holes 5, the second embodiment of the present invention includes adjustable pilot holes 5.

At least one sliding block 14 is positioned on the drill plate 3 so as to permit adjustable pilot holes 5. The sliding block 14 includes at least one slot 13 and at least one pilot hole 5. To use the second embodiment of the present invention, a user measures the distance from one side edge of a drawer 10 and adjusts the drill plate 3 and/or suspension plate 2 via sliding the drill plate 3 up and down along the poles 4 and tightening the thumb screws 6 on the suspension plate 2. Then, the user adjusts the sliding blocks 14 horizontally along the drill plate 3 such that the pilot holes 5 on the sliding blocks 14 are in the desired position in front of the drawer face 9. The user then tightens the thumb screws 6 that are inserted through the slots 13 on the sliding blocks 14 and into the apertures for thumb screws 17 located on the drill plate 3. Because the diameter of the slots 13 on the sliding blocks 14 are smaller than the diameter of the thumb screws 6, when the thumb screws are tightened against the sliding blocks 14, the sliding blocks 14 are locked in place.

Once again, the pilot holes 5 preferably include steel bushings 16 for durability. The apertures for thumb screws 17 are preferably threaded so as to permit an interlocking fit of the thumb screws 6. Markings 12 are located on the drill plate 3 so as to easily permit a user to adjust the location of the pilot holes 5 on the drill plate 3 to a desired distance.

The pilot holes 5 on the sliding blocks 14 are positionable only in front of the slot 13 on the drill plate 3 so as to permit a person to drill a hole for a knob pull. When finished with a first drawer, the user need only measure the distance from one side of a second drawer to find the center and position the jig 1 in the center in order to locate an identically-positioned hole for drilling.

Although the use of thumb screws 6 is described for locking the plates 2 and 3 and sliding blocks 14 in place, other fastening means, such as screws, nuts and bolts, wingnuts and the like may be used.

The use of the present invention will allow a person to quickly identify the location of a hole to be drilled on a drawer for a knob pull in an accurate and precise manner.

It is to be understood that while a preferred embodiment of the invention is illustrated, it is not to be limited to the specific form or arrangement of parts herein described and shown. It will be apparent to those skilled in the art that various changes may be made without departing from the scope of the invention and the invention is not be considered limited to what is shown and described in the specification and drawings.

Having thus described my invention, I claim:

1. A drawer knob pull measuring jig comprising:
a suspension plate having a horizontal side and a vertical side;
said horizontal side being connected perpendicularly to said vertical side;
at least one aperture for acceptance of a pole located in said vertical side;
a drill plate having at least one pilot hole;
said drill plate having at least one aperture for acceptance of a pole; and
at least one pole which is insertable into said at least one aperture on said suspension plate; and
said at least one pole is insertable into said at least one aperture on said drill plate.

2. The drawer knob pull measuring jig of claim 1 further comprising:
a means for locking said suspension plate to said pole.

3. The drawer knob pull measuring jig of claim 1 further comprising:
a means for locking said drill plate to said pole.

4. The drawer knob pull measuring jig of claim 2 wherein:
said suspension plate has at least one aperture for acceptance of a thumb screw; and
said means for locking is a thumb screw.

5. The drawer knob pull measuring jig of claim 3 wherein:
said drill plate has at least one aperture for acceptance of a thumb screw; and
said means for locking is a thumb screw.

6. The drawer knob pull measuring jig of claim 1 wherein:
at least one marking is located on said at least one pole.

7. The drawer knob pull measuring jig of claim 1 wherein:
a steel bushing is inserted into said at least one pilot hole.

8. The drawer knob pull measuring jig of claim 1 wherein:
at least one marking is located adjacent to said at least one pilot hole.

9. The drawer knob pull measuring jig of claim 1 further comprising:
at least one sliding block slidingly secured to said drill plate.

10. The drawer knob pull measuring jig of claim 9 further comprising:
at least one slot located on said drill plate.

11. The drawer knob pull measuring jig of claim 10 further comprising:
at least one aperture located on said sliding block for acceptance of a locking means.

12. The drawer knob pull measuring jig of claim 11 wherein:
said locking means is a thumb screw.

13. The drawer knob pull measuring jig of claim 9 wherein:
at least one pilot hole is located on said at least one sliding block.

14. The drawer knob pull measuring jig of claim 13 further comprising:
at least one slot located on said drill plate.

15. The drawer knob pull measuring jig of claim 14 further comprising:
at least one aperture located on said sliding block for acceptance of a locking means.

16. The drawer knob pull measuring jig of claim 15 wherein:
said locking means is a thumb screw.

17. The drawer knob pull measuring jig of claim 14 wherein:
a steel bushing is inserted into said at least one pilot hole.

18. The drawer knob pull measuring jig of claim 9 wherein:
at least one marking is located adjacent to said at least one pilot hole.

19. A drawer knob pull measuring jig comprising:
a suspension plate having a horizontal side and a vertical side;
said horizontal side being connected perpendicularly to said vertical side;
at least one aperture for acceptance of a pole located in said vertical side;
a drill plate having at least one pilot hole;
said drill plate having at least one aperture for acceptance of a pole;
at least one pole which is insertable into said at least one aperture on said suspension plate;
said at least one pole is insertable into said at least one aperture on said drill plate;
said suspension plate has at least one aperture for acceptance of a thumb screw;
said drill plate has at least one aperture for acceptance of a thumb screw;
at least one marking is located on said at least one pole;
a steel bushing is inserted into said at least one pilot hole; and
at least one marking is located adjacent to said at least one pilot hole.

20. A drawer knob pull measuring jig comprising:
a suspension plate having a horizontal side and a vertical side;
said horizontal side being connected perpendicularly to said vertical side;
at least one aperture for acceptance of a pole located in said vertical side;
a drill plate having at least one pilot hole;
said drill plate having at least one aperture for acceptance of a pole;
at least one pole which is insertable into said at least one aperture on said suspension plate;
said at least one pole is insertable into said at least one aperture on said drill plate;
at least one sliding block slidingly secured to said drill plate;
at least one slot located on said drill plate;
at least one aperture located on said sliding block for acceptance of a thumb screw;
at least one pilot hole is located on said at least one sliding block;
at least one slot located on said drill plate;
at least one aperture located on said sliding block for acceptance of a thumb screw;
a steel bushing is inserted into said at least one pilot hole; and
at least one marking is located adjacent to said at least one pilot hole.
